(19) United States
(12) Patent Application Publication
(10) Pub. No.: US 2009/0013261 A1
(43) Pub. Date: Jan. 8, 2009

(54) DISPLAY APPARATUS

(76) Inventors: Yoshimune NODA, Nara-shi (JP); Mikiya Okada, Nara-shi (JP)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 12/142,840

(22) Filed: Jun. 20, 2008

(30) Foreign Application Priority Data
Jul. 3, 2007 (JP) 2007-175169

(51) Int. Cl. G06F 3/041

(52) U.S. Cl. 715/750

(57) ABSTRACT

A display apparatus is provided, that is capable of, even when an icon displayed to a viewer who is positioned in a different view angle direction is erroneously operated, preventing an execution of processing concerning the wrong operation. As shown by the reference numeral M, when a viewer X who is positioned in a predetermined view angle direction (left side) erroneously operates an icon Y displayed to a viewer Y who is positioned in a different view angle direction (right side) from that direction, an icon display control portion displays dialogs for requesting an input as to whether or not processing concerning the operated icon is required on display screens. Based on an input operation in the dialog displayed in the view angle direction of the icon Y, the icon execution control portion performs a control of the execution of the processing concerning the icon.

### CROSS-NOTING PARAGRAPH

This Non-provisional application claims priority under 35 U.S.C. §119(a) on Patent Application No. 2007-175169 filed in JAPAN on Jul. 3, 2007, the entire contents of which are hereby incorporated herein by reference.

### FIELD OF THE INVENTION

The present invention relates to a display apparatus, particularly to a display apparatus having a multiple-display function and provided with a touch sensor.

### BACKGROUND OF THE INVENTION

A liquid crystal panel having a multiple-display function, for example, a dual-view display function (hereinafter, referred to as a dual view liquid crystal) is able to display an image on a display screen for a viewer who is positioned in a predetermined view angle direction, at the same time, individually display a separate image from the image for another viewer who is positioned in a different view angle direction from the view angle direction (Japanese Laid-Open Patent Publication No. 2005-78076).

Here, the principle of a dual-view display will be described using FIG. 6.

A view barrier 101, which is a filter having many transparent slits separated by opaque regions (black parts), splits light beam from backlight (not shown) which has transmitted through a liquid crystal panel 102 into left and right.

As shown in the Figure, light beam transmitted through a pixel x of the liquid crystal panel 102 transmits through a transparent slit of the view barrier 101 and reaches to a viewer X who is positioned in a predetermined view angle direction (left side) to the liquid crystal panel 102. Similarly, light beam transmitted through a pixel y of the liquid crystal panel transmits through a transparent slit of the view barrier 101 and reaches to a viewer Y who is positioned in a different view angle direction (right side) from the predetermined view angle direction to the liquid crystal panel 102.

In addition, different image data is outputted onto the liquid crystal panel 102 for each pixel or for a plurality of pixels depending on the width or space of transparent slits of the view barrier 101, and thereby different images can be displayed by splitting each of them with the visual field barrier 101.

By using such a dual-view liquid crystal together with a touch sensor, it can be served as a dual-view liquid crystal touch sensor.

Normally, operators, for example, icons are displayed on the dual-view liquid crystal touch sensor, and, in order to execute processing concerning the icons properly, as shown in FIG. 7A, it is required to arrange icons X displayed to the viewer X who is positioned in the predetermined view angle direction (left side) to a display screen 110 and icons Y displayed to the viewer Y who is positioned in the different view angle direction (right side) from the predetermined view angle direction, so that display areas of the icons X and Y are not overlapped. Japanese Laid-Open Patent Publication No. 2005-284592 discloses a display apparatus capable of arranging icons in that way.

Here, FIG. 7B shows a display screen 110L viewed by the viewer X who is positioned in the predetermined view angle direction (left side), and FIG. 7C shows a display screen 110R viewed by the viewer Y who is positioned in the different view angle direction (right side) from the predetermined view angle direction.

However, when the display apparatus disclosed in Japanese Laid-Open Patent Publication No. 2005-284592 is used, as shown by the reference numeral M in FIG. 8A, the viewer X who is positioned in the predetermined view angle direction (left side) can erroneously operate the icons Y displayed to the viewer Y who is positioned in the different view angle direction (right side) from the predetermined view angle direction. In particular, when drawing software is executed and pictures are drawn on the display screen using stylus etc., it is more likely to make such a wrong operation.

In this case, when processing (for example, print processing) concerning the icons Y is immediately executed, unexpected processing can be executed suddenly by the operation of the icons Y, thus there is a problem that the viewer Y is confused.

### SUMMARY OF THE INVENTION

An object of the present invention is to provide a display apparatus capable of, even when an icon displayed to a viewer who is positioned in a different view angle direction is erroneously operated, preventing an execution of processing concerning the wrong operation.

Another object of the present invention is to provide a display apparatus that has a multiple-display function for displaying an image on a display screen for a viewer who is positioned in a predetermined view angle direction, at the same time, individually displaying a separate image from the image for another viewer who is positioned in a different view angle direction from the view angle direction, and that is provided with a touch sensor, comprising an icon display control portion that displays an icon individually to each of the viewer positioned in the predetermined view angle direction and another, and an icon operation control portion that performs a control of execution of processing concerning the icon, wherein when the icon is operated, the icon display control portion displays dialogs for requesting an input as to whether or not the processing concerning the operated icon is required to be executed for the viewers positioned in each of the view angle directions, and the icon operation control portion, based on the input in the dialog displayed in the view angle direction of the icon operated first, performs the control of the execution of the processing concerning the operated icon.

Another object of the present invention is to provide a display apparatus, wherein the icon display control portion displays a display for instructing to execute the processing concerning the operated icon more largely than a display for instructing not to execute the processing in the dialog displayed in the view angle direction of the operated icon.

Another object of the present invention is to provide a display apparatus, wherein the icon display control portion displays information indicative of the operated icon together with the dialog on the display screen visible in the another direction than the direction of the operated icon.

### BRIEF DESCRIPTION OF THE DRAWINGS

FIGS. 1A and 1B are diagrams showing an example of a dialog displayed when a viewer X erroneously operates an icon Y;

FIGS. 2A and 2B are diagrams showing an example of a dialog displayed when the viewer X operates an icon X;

FIG. 3 is a block diagram of a display apparatus according to the present invention;

FIG. 4 is a flowchart illustrating processing from an operation of an icon to the start of processing concerning the icon;

FIGS. 5A and 5B show an example of a dialog in which convenience of a button operation is improved;

FIG. 6 is a diagram illustrating the principle of a dual-view display;

FIGS. 7A to 7C are diagrams showing icons displayed on a display screen; and

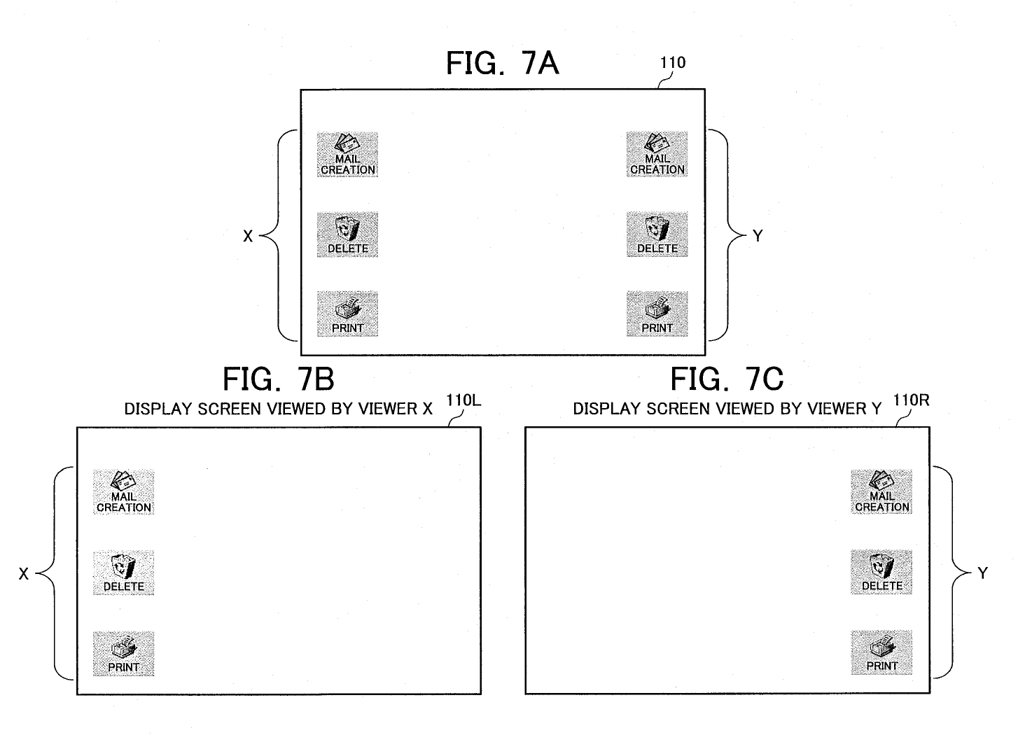

FIGS. 8A and 8B are diagrams illustrating an example of a wrong operation of an icon.

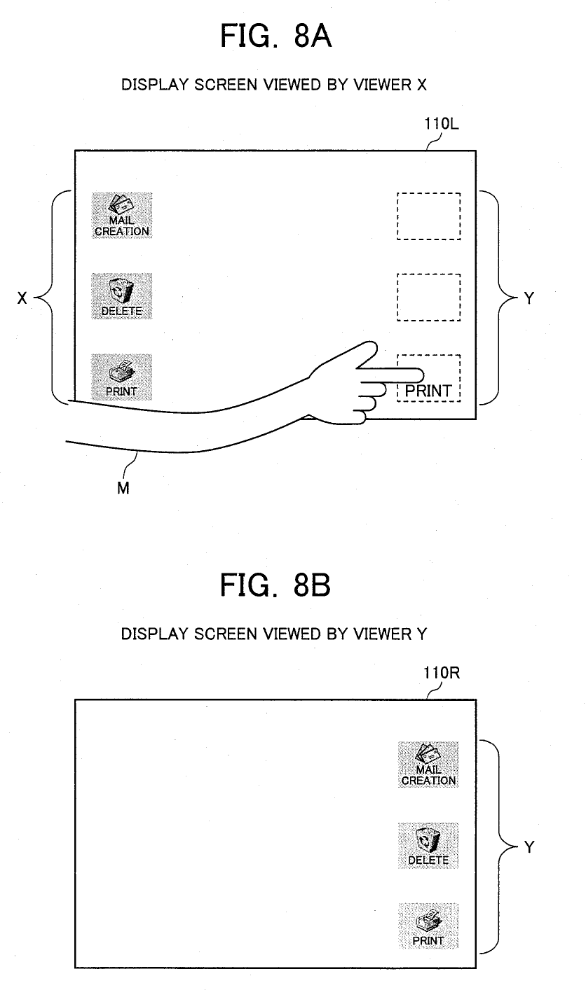

### PREFERRED EMBODIMENTS OF THE INVENTION

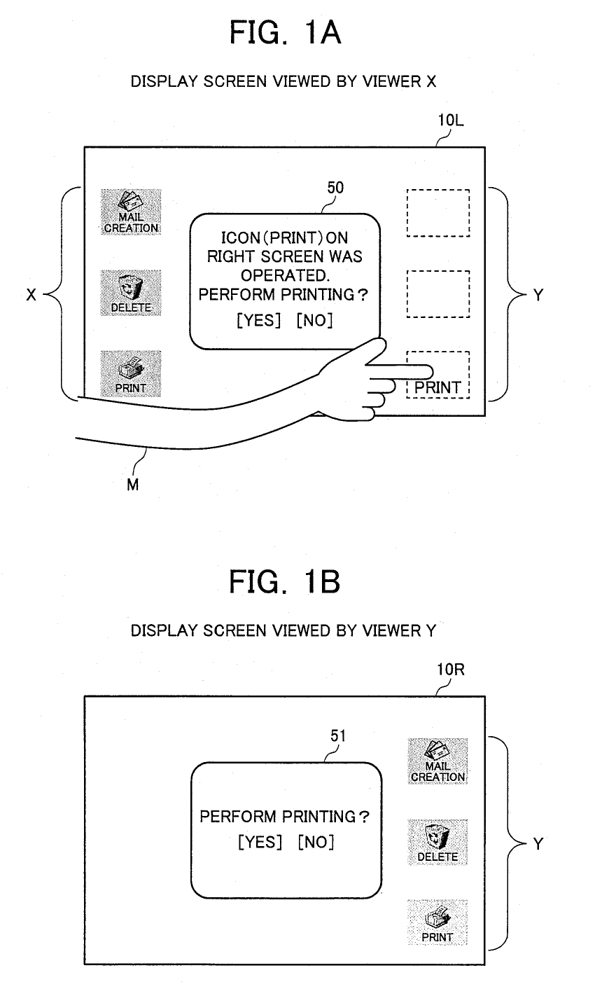

A dialog displayed on a display screen when a viewer erroneously operates an icon for requesting an input as to whether or not the execution of the processing for the erroneous operation is necessary, will be described using FIGS. 1A and 1B.

(Wrong Operation of Icon Y by Viewer X)

As shown by the reference numeral M in FIG. 1A, when a viewer X who is positioned in a predetermined view angle direction (left side) erroneously operates an icon Y displayed for a viewer Y who is positioned in a different view angle direction (right side) from the predetermined view angle direction, dialogs 50 and 51 for requesting an input as to whether or not processing concerning the operated icon is required to be executed, are displayed on display screens 10L and 10R.

The dialog 50 is a dialog displayed for the viewer X positioned in the different view angle direction from the view angle direction of the operated icon Y, who has erroneously operated the icon Y.

In the dialog 50 of the display screen 10L, with the information showing that the icon Y displayed for the viewer Y who is positioned in the different view angle direction from that of the viewer X was operated (information indicative of the operated icon), for example, a sentence of “icon (print) on the right screen was operated”, a sentence of “perform printing?” for requesting an input as to whether or not processing of the icon is required to be executed, and a display for instructing to execute the processing, for example, an [YES] button, and a display for instructing not to execute the processing, for example, a [NO] button, are displayed together.

In this case, the viewer X who has erroneously operated the icon Y normally recognizes to have erroneously operated the icon Y, and operates the [NO] button so as not to execute the processing concerning the icon Y (cancelling the operation). Here, even if the viewer X operates the [YES] button without recognizing the wrong operation of the icon Y displayed for the viewer Y, the processing is not executed.

On the other hand, in the dialog 51 displayed on the display screen 10R for the viewer Y who is positioned in the view angle direction of the operated icon Y, an [YES] button for instructing to execute the processing and a [NO] button for instructing not to execute the processing, are displayed together with a sentence of “perform printing?” for requesting an input as to whether or not processing of the icon is required to be executed.

In this case, since the viewer Y does not intend to execute the processing concerning the icon Y, normally, the [NO] button is operated. Note that, if the viewer Y mistakenly operates the [YES] button, the processing is to be executed, but which will not happen normally.

Thereby, in the present invention, the operation of the icon is controlled based on an input operation in the dialog 51 displayed in the view angle direction of the operated icon, and therefore the operation for the icon is to be cancelled.

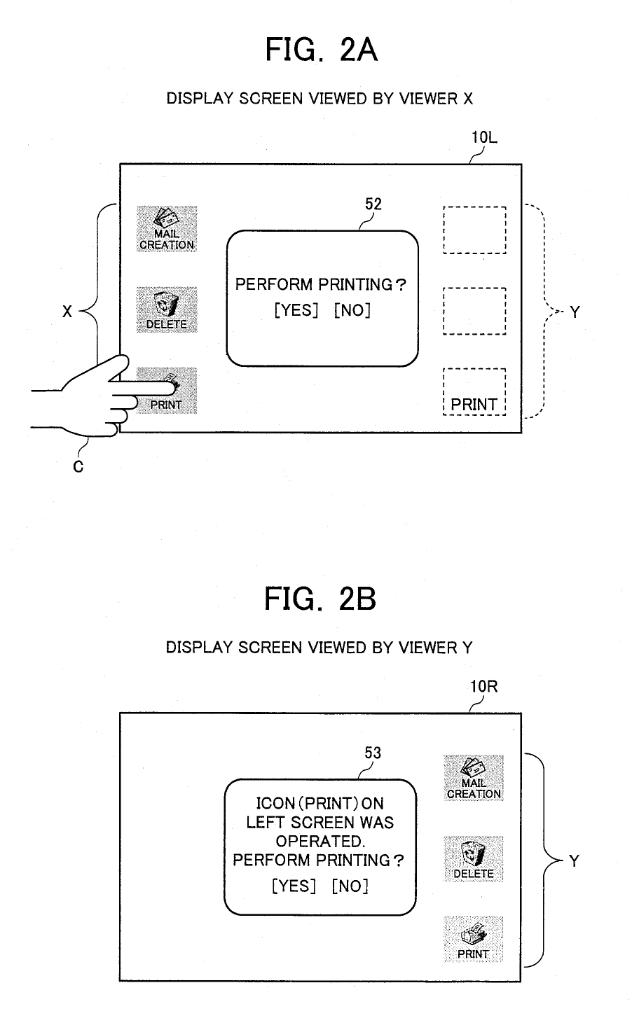

Next, a dialog displayed on a display screen when the viewer X operates an icon X for requesting an input as to whether or not processing concerning the operation is required to be executed, will be described using FIGS. 2A and 2B.

(Operation of Icon X by Viewer X)

As shown by the reference numeral C in FIG. 2A, when the viewer X who is positioned in the predetermined view angle direction (left side) operates (but not erroneously) an icon X displayed for the viewer X, dialogs 52 and 53 for requesting an input as to whether or not processing concerning the operated icon is required to be executed, are displayed on the display screens 10L and 10R.

The dialog 52 is a dialog displayed for the viewer X who is positioned in the view angle direction of the operated icon X.

In the dialog 52, an [YES] button for instructing to execute the processing and a [NO] button for instructing not to execute the processing are displayed together with a sentence of “perform printing?” for requesting an input as to whether or not processing concerning the icon is required to be executed.

In this case, since the viewer X intends to execute the processing concerning the icon X, the [YES] button is operated to execute the processing.

In addition, when the viewer X changes his or her mind and operates the [NO] button to stop the execution of the print processing, the print processing is not executed.

On the other hand, on the display screen 10R, the dialog 53 for requesting an input as to whether or not processing concerning the operated icon (print on the left screen) is displayed.

The dialog 53 is a dialog displayed for the viewer Y who is positioned in the different view angle direction from the predetermined view angle direction in which the operated icon X is displayed.

In the dialog 53, a sentence of “perform printing?” for requesting an input as to whether or not processing of the icon is required to be executed, and an [YES] button for instructing to execute the processing and a [NO] button for instructing not to execute the processing, are displayed together with information showing that the icon X displayed for the viewer X was operated, for example, a sentence of “icon (print) on the left screen was operated”.

In this case, since the viewer Y does not intend to execute the processing concerning the icon X, normally, the [NO] button is operated. Here, even if the viewer Y mistakenly operates the [YES] button, the operation of the icon is controlled based on an input operation in the dialog 52 displayed in the view angle direction of the operated icon, and therefore the operation is to be cancelled. In other words, the operation of the [YES] and [NO] buttons are to be ignored.

Although the above describes the dialogs displayed when the viewer X erroneously operates the icon Y and when the viewer X operates the icon X, this is the same as the case when the viewers X and Y, and the icons X and Y are replaced, respectively.

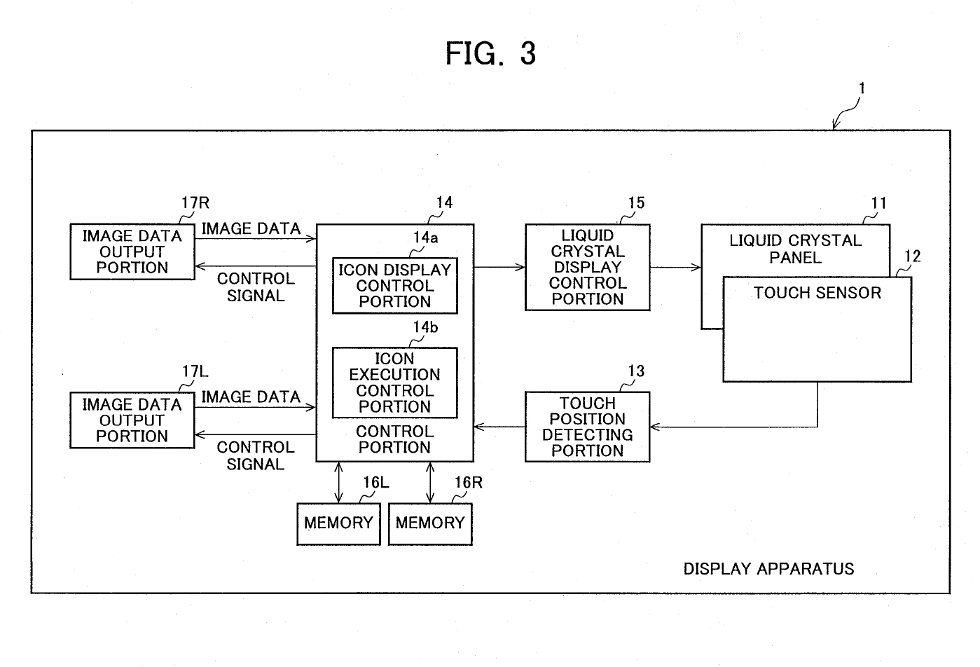

FIG. 3 is a block diagram of a display apparatus according to the present invention, where 1 denotes the display apparatus.

The display apparatus 1 has a multiple-display function for displaying an image on a display screen for a viewer who is positioned in a predetermined view angle direction, at the same time, displaying a separate image from the image for another viewer who is positioned in a different view angle direction from the view angle direction, and further comprises a touch sensor.

11 denotes a liquid crystal panel. The liquid crystal panel 11 is a liquid crystal panel capable of displaying a dual-view screen provided with the view barrier above (not shown), which constitutes the display screens (10R, 10L) together with a touch sensor 12 below. The panel 11 has a liquid crystal layer with anisotropic dielectric constant, which is disposed between two substrates (not shown), and adjusts the amount of light from backlight (not shown) depending on the strength of an electric field applied to the liquid crystal layer to display an image.

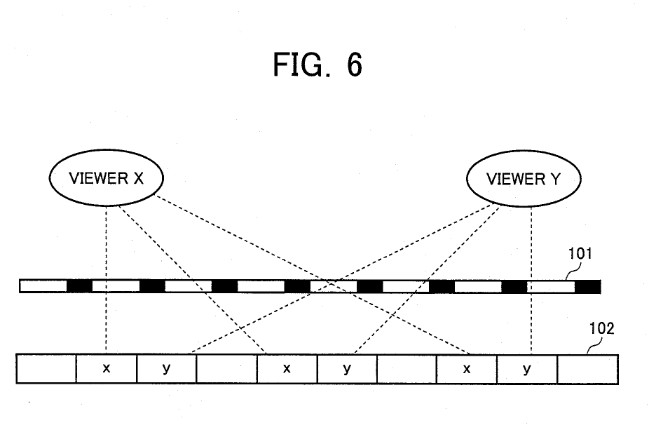

In order to cause the liquid crystal panel 11 to perform a dual-view display, for example, as illustrated in FIG. 6, each pixel of the liquid crystal panel 11 may be driven so that an image displayed to the viewer who is positioned in the predetermined view angle direction to the display screen of the liquid crystal panel 11 is displayed, and that an image displayed to the viewer who is positioned in the different view angle direction from the predetermined view angle direction is displayed, and as a method of which, various methods that have been proposed can be employed.

The touch sensor 12 is provided on the entire liquid crystal panel 11, and when an approach or contact of finger etc., of a viewer to the panel 11 is detected by an infrared ray shielding method, a ultrasonic surface acoustic wave method, and an electrostatic capacity method, etc., then a touch position detecting portion 13 calculates a coordinate value (touch coordinate value) that the viewer has touched to output to a control portion 14. The control portion 14 can recognize the position that the viewer has touched by the inputted touch coordinate value.

The control portion 14 performs a control of processing to output, to a liquid crystal display control portion 15, image data outputted by an image data output portion 17L for outputting image data displayed to the viewer who is positioned in the predetermined view angle direction and image data outputted by an image data output portion 17R for outputting image data displayed to the viewer who is positioned in the different view angle direction from the predetermined view angle direction, and performs a control of each function block.

Further, the control portion 14 has an icon display control portion 14a that displays icons individually for each of the viewers positioned in the predetermined view angle direction and in the different view angle direction from the direction, and an icon execution control portion 14b that performs a control of the execution of processing concerning the icon.

The icon display control portion 14a outputs icon data stored in a memory 16L, including display information and operation information concerning an icon on an image displayed to the viewer who is positioned in the predetermined view angle direction, to the liquid crystal display control portion 15. Note that, the display information means the information of the display position or shape etc., of the icon, and the operation information means the information of operation contents (such as printing) executed by the operation of the icon.

Similarly, the display control portion 14a outputs icon data stored in a memory 16R, including display information and operation information concerning an icon on an image displayed to the viewer who is positioned in the different view angle direction from the predetermined view angle direction, to the liquid crystal display control portion 15.

At this time, a display control is performed so that the icon displayed in the predetermined view angle direction and the icon displayed in the different view angle direction from the predetermined view angle direction are not overlapped.

In addition, when an icon is operated, as described above, the icon display control portion 14a displays dialogs for requesting an input as to whether or not processing concerning the icon operated first is required to be executed for the viewers positioned in each of the view angle directions.

Moreover, information indicative of the operated icon, for example, the sentence of “an icon (print) in the right screen was operated” in FIG. 1A is displayed as the dialog, to the viewer who is positioned in the different view angle direction from the view angle direction of the icon.

Based on an input operation in the dialog displayed in the view angle direction of the icon operated first for requesting an input as to whether or not processing is required to be executed, the icon execution control portion 14b performs a control of the execution of the processing concerning the operated icon.

For example, as illustrated in FIGS. 1A and 1B, the control is performed so that the processing is not performed even when the viewer X erroneously operates the icon Y at first and operates an [YES] button of the dialog 50 displayed to the viewer X.

On the other hand, as illustrated in FIGS. 2A and 2B, when the viewer X operates a correct icon at first and operates an [YES] button of the dialog 52 displayed to the viewer X, the processing concerning the icon is to be executed.

The liquid crystal display control portion 15 carries out predetermined processing for each of image data so that image data etc., displayed to the viewer who is positioned in the predetermined view angle direction and image data etc., displayed to the viewer who is positioned in the different view angle direction from the predetermined view angle direction, which are outputted by the control portion 14, are displayed in the dual-view manner, and outputs the data to the liquid crystal panel 11 and drives each pixel of the panel 11. At this time, the liquid crystal display control portion 15 also outputs a control signal required to control a display operation of the liquid crystal panel 11 together.

The memory 16L stores icon data including display information and operation information concerning an icon on an image displayed to the viewer who is positioned in the predetermined view angle direction, and data for dialogs.

The memory 16R stores icon data including display information and operation information concerning an icon on an image displayed to the viewer who is positioned in the different view angle direction from the predetermined view angle direction, and data for dialogs.

The image data output portion 17L fetches the image data to be displayed to the viewer who is positioned in the predetermined view angle direction from not-shown recording medium etc., to output to the control portion 14.

Similarly, the image data output portion 17R fetches the image data to be displayed to the viewer who is positioned in the different view angle direction from the predetermined view angle direction from not-shown recording medium etc., to output to the control portion 14.

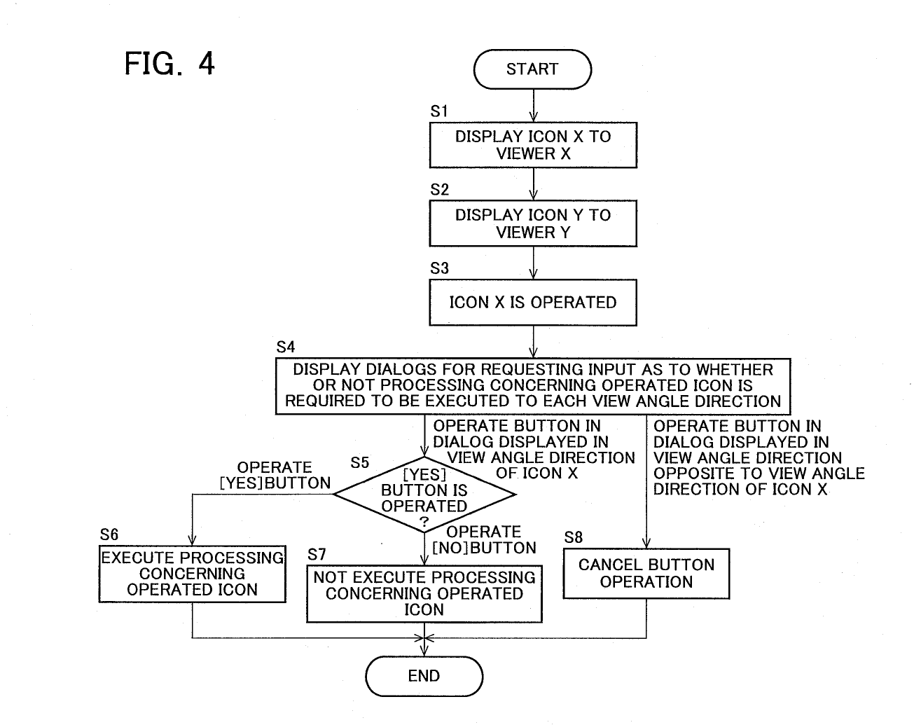

Next, the control of processing concerning an icon X, that is performed after the icon X is operated and a dialog is displayed by the operation, through the displayed dialog, will be described using a flowchart of FIG. 4.

Note that, also when an icon Y is operated, similarly, a dialog is displayed and processing concerning the icon Y is controlled through the displayed dialog.

The icon display control portion 14a displays an icon X to the viewer X (step S1) and, at the same time, displays an icon Y to the viewer Y (step S2).

Subsequently, when the icon X is operated (step S3) dialogs for requesting an input as to whether or not processing concerning the operated icon X is required to be executed (for example, the dialogs 52 and 53 in FIGS. 2A and 2B) are displayed in each of view angle directions, in other words, a view angle direction of the icon X and a view angle direction opposite to the view angle direction (step S4).

When an [YES] button of the dialog displayed in the view angle direction of the icon X is operated (step S5/operation of the [YES] button), the processing concerning the operated icon is executed (step S6). When the viewer X operates a [NO] button of the dialog (step S5/operation of the [NO] button), the processing concerning the operated icon is not executed (step S7).

Even when [YES] and [NO] buttons of the dialog displayed in the view angle direction opposite to the view angle direction of the icon X are operated, the operation of the buttons is cancelled (step S8).

[Others]

Next, a method to improve the viewer's convenience when a viewer operates [YES] and [NO] buttons of a dialog will be described.

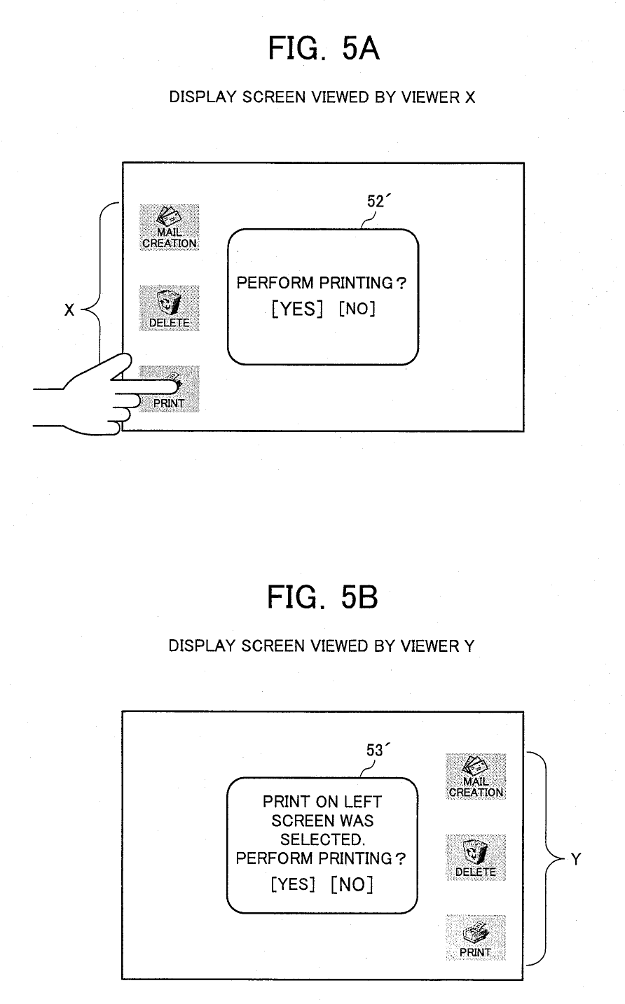

As illustrated in FIG. 2A, the dialog 52 is displayed to the viewer X by the operation of an icon X, in which since the viewer X intends to execute the processing concerning the icon X, an [YES] button of the dialog 52 is operated. Then, as a dialog 52′ of FIG. 5A, the icon display control portion 14a displays the [YES] button more largely than the [NO] button.

Similarly, the dialog 53 is displayed to the viewer Y, in which since the viewer Y does not intend to execute the processing concerning the icon X, a [NO] button of the dialog 53 is operated. Then, as a dialog 53′ of FIG. 5B, the icon display control portion 14a displays the [NO] button more largely than the [YES] button.

Although an icon is illustrated herein as an operator, not only the icon, but a button or each item in an item selection table may be applicable.

According to the present invention, even when an icon displayed to a viewer who is positioned in a different view angle direction is erroneously operated, it is possible to prevent the execution of the processing concerning the wrong operation by displaying a dialog (Dialog Box) for requesting an input as to whether or not processing concerning the wrong operation is required to be executed, and therefore, the viewer is not confused with the wrong operation.

1. A display apparatus that has a multiple-display function for displaying an image on a display screen for a viewer who is positioned in a predetermined view angle direction, at the same time, individually displaying a separate image from the image for another viewer who is positioned in a different view angle direction from the view angle direction, and that is provided with a touch sensor, comprising:
an icon display control portion that displays an icon individually to each of the viewer positioned in the predetermined view angle direction and another; and
an icon operation control portion that performs a control of an execution of processing concerning the icon, wherein
when the icon is operated, the icon display control portion displays dialogs for requesting an input as to whether or not the processing concerning the operated icon is required to be executed for the viewers positioned in each of the view angle directions, and
the icon operation control portion, based on the input in the dialog displayed in the view angle direction of the icon operated first, performs the control of the execution of the processing concerning the operated icon.

2. The display apparatus as defined in claim 1, wherein
the icon display control portion displays a display for instructing to execute the processing concerning the operated icon more largely than a display for instructing not to execute the processing, in the dialog displayed in the view angle direction of the operated icon.

3. The display apparatus as defined in claim 1, wherein
the icon display control portion displays information indicative of the operated icon together with the dialog on the display screen visible in the another direction than the direction of the operated icon.
